(19) United States
(12) Patent Application Publication
(10) Pub. No.: US 2013/0311282 A1
(43) Pub. Date: Nov. 21, 2013

(54) MARKETING COMMUNICATION MANAGEMENT SYSTEM

(71) Applicants: Robert C. Cochrane, II, Westfield, IN (US); Chad Hankinson, Westfield, IN (US); Ryan Allen, Noblesville, IN (US)

(72) Inventors: Robert C. Cochrane, II, Westfield, IN (US); Chad Hankinson, Westfield, IN (US); Ryan Allen, Noblesville, IN (US)

(21) Appl. No.: 13/476,546

(22) Filed: May 21, 2012

(51) Int. Cl. G06Q 30/02

(52) U.S. Cl. 705/14.53; 705/14.49

(57) ABSTRACT

Disclosed is a computer implemented marketing communication management system and method enabling a point of sale provider who offers goods and/or services for sale and who maintains a customer information database, to use a marketing management software application provided by a software provider to create, schedule delivery and analyze targeted electronic marketing communications via one or more selected electronic communication methods to all or selected subsets of the provider's subscribed customers. A non-limiting example system is specifically discussed and illustrated as adapted for use in a tanning or beauty salon business offering indoor tanning services to customers using ultraviolet or sunless tanning equipment and offering for sale to customers associated tanning products such as skin care preparations and eye protection products.

### FIELD OF THE INVENTION

Aspects of the present disclosure deal with marketing communication management systems.

### BACKGROUND

Traditional marketing communication methods, such as postal mailings, are typically generated by a point of sale provider and delivered to customers relatively slowly. The receipt, effectiveness and targeting accuracy of such communications is often difficult to measure. With the advent of instant or virtually instant electronic communications media such as email messages and text messages, the speed of delivery is increased and more options for tracking delivery and effectiveness are available. Still further, with the introduction of social media platforms, there is an enhanced opportunity and need for a point of sale provider to send desired communications and to quickly react to comments and postings from others. While using one or more of these communications methods is necessary or desirable for a point of sale provider to promote and manage a business, the investment of resources to create, manage and analyze marketing communications can be complex and can involve a significant time for learning and then using multiple communication channels. Aspects of the present disclosure preferably assist a point of sale provider to efficiently manage marketing communications.

### SUMMARY

Disclosed is a computer implemented marketing communication management system and method enabling a point of sale provider who offers goods and/or services for sale and who maintains a customer information database, to use a marketing management software application provided by a software provider to create, schedule delivery and analyze targeted electronic marketing communications via one or more selected electronic communication methods to all or selected subsets of the provider's subscribed customers. A non-limiting example system is specifically discussed and illustrated as adapted for use in a tanning or beauty salon business offering indoor tanning services to customers using ultraviolet or sunless tanning equipment and offering for sale to customers associated tanning products such as skin care preparations and eye protection products.

In certain embodiments, the system enables the point of sale provider to create marketing messages for delivery at specific times or for delivery in response to certain events triggered by a customer's purchasing history at a point of sale location and in accordance with indoor tanning industry based standards.

In certain embodiments, the system incorporates marketing content supplied by third party equipment and product suppliers corresponding to equipment used in providing services or products offered for sale by the point of sale provider. The system preferably enables the point of sale provider to incorporate up-to-date supplier provided marketing content into electronic marketing communications.

This summary is provided to introduce a selection of concepts in a simplified form that are described in further detail in the detailed description and drawings contained herein. This summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein.

### BRIEF DESCRIPTION OF THE DRAWINGS

FIG. 1 illustrates a diagrammatic view of a system for use in certain embodiments of the present invention as shown.

FIG. 2 is an example graphical user interface usable with an embodiment of the system illustrated in FIG. 1.

FIG. 3 illustrates an initial screen usable with an embodiment of the system illustrated in FIG. 1.

FIG. 4 illustrates a subscriber screen usable with an embodiment of the system illustrated in FIG. 1.

FIG. 5 illustrates an email page usable with an embodiment of the system illustrated in FIG. 1.

FIG. 6-7 illustrate email creation pages usable with an embodiment of the system illustrated in FIG. 1.

FIGS. 8-11 illustrate email message templates or images usable with an embodiment of the system illustrated in FIG. 1.

FIG. 12 illustrates an email message with content usable with an embodiment of the system illustrated in FIG. 1.

FIG. 13 illustrates a summary of email messages usable with an embodiment of the system illustrated in FIG. 1.

FIG. 14 illustrates an auto configuration screen usable with an embodiment of the system illustrated in FIG. 1.

FIG. 15 illustrates a further auto configuration screen usable with an embodiment of the system illustrated in FIG. 1.

FIG. 16 illustrates a scheduling screen usable with an embodiment of the system illustrated in FIG. 1.

FIG. 17 illustrates a social media control screen usable with an embodiment of the system illustrated in FIG. 1.

FIG. 18 illustrates an example tool for scheduling social media communications usable with an embodiment of the system illustrated in FIG. 1.

FIG. 19 illustrates a sample analytics or reporting screen usable with an embodiment of the system illustrated in FIG. 1.

FIG. 20 illustrates a social overview screen usable with an embodiment of the system illustrated in FIG. 1.

FIG. 21 illustrates an email reporting screen usable with an embodiment of the system illustrated in FIG. 1.

### DESCRIPTION OF SPECIFIC EMBODIMENTS

For the purposes of promoting an understanding of the principles of the disclosure, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art to which the invention relates.

Disclosed is a computer implemented marketing communication management system and method enabling a point of sale provider who offers goods and/or services for sale and who maintains a customer information database, to work with a marketing management software application provided by a software provider to electronically create and schedule delivery of targeted electronic marketing communications via one or more selected electronic communication methods to selected subsets of the provider's subscribed customers.

The system optionally allows a point of service provider to send communications and to monitor social media platforms in order to more quickly monitor and respond to customer or third party postings. An example system is specifically discussed and illustrated as adapted for use in a tanning or beauty salon business offering indoor tanning services using ultraviolet or sunless tanning equipment and offering for sale to customers associated tanning products such as tanning preparations, skin care preparations and eye protection products.

In certain embodiments, the system enables the point of sale provider to create marketing messages for delivery at specific times or for delivery in response to certain events triggered by a customer's behavior at a point of sale location and in accordance with indoor tanning industry based guidelines.

In certain embodiments, the system incorporates updatable marketing content supplied by third party equipment and product suppliers corresponding to equipment used in providing services or products offered for sale by the point of sale provider. The system preferably enables the point of sale provider to incorporate up-to-date supplier provided marketing content into electronic marketing communications.

In certain embodiments, the system transmits the marketing communication from the marketing management software to the selected subset of subscribed customers using one or more electronic communication methods, including but not limited to electronic mail messages, wireless text messages and postings to social media and marketing forums such as offered by FACEBOOK, Inc. or TWITTER, Inc. The marketing communication may be an email message, an audio message suitable for delivery to the user's voicemail, a text message deliverable via SMS, a video/animation file, or another form of content capable of being transmitted to one or more of a variety of differing user devices. The software provider may be compensated for the service by the point of sale provider, through advertisement revenue generated by the placement of advertisements within the content, or through a combination of these or other revenue models.

In certain embodiments, the system incorporates a social media monitoring and reporting function which monitors and displays communication activity and information from two or more forms of social media and allows original or responsive communications from the point of sale provider. In certain embodiments, the system incorporates an email and/or text message analytical and reporting function.

In a preferred embodiment, the marketing messages deliver content only to permission based end customers. In this embodiment, the customers may opt-in to the service using a variety of methods such as by providing their contact information to an entity, dialing a specified phone number, providing information to a web site, sending a text message to a specified number, responding to an e-mail, belonging to an organization, such as a salon customer club, or by various other methods known to one of skill in the art.

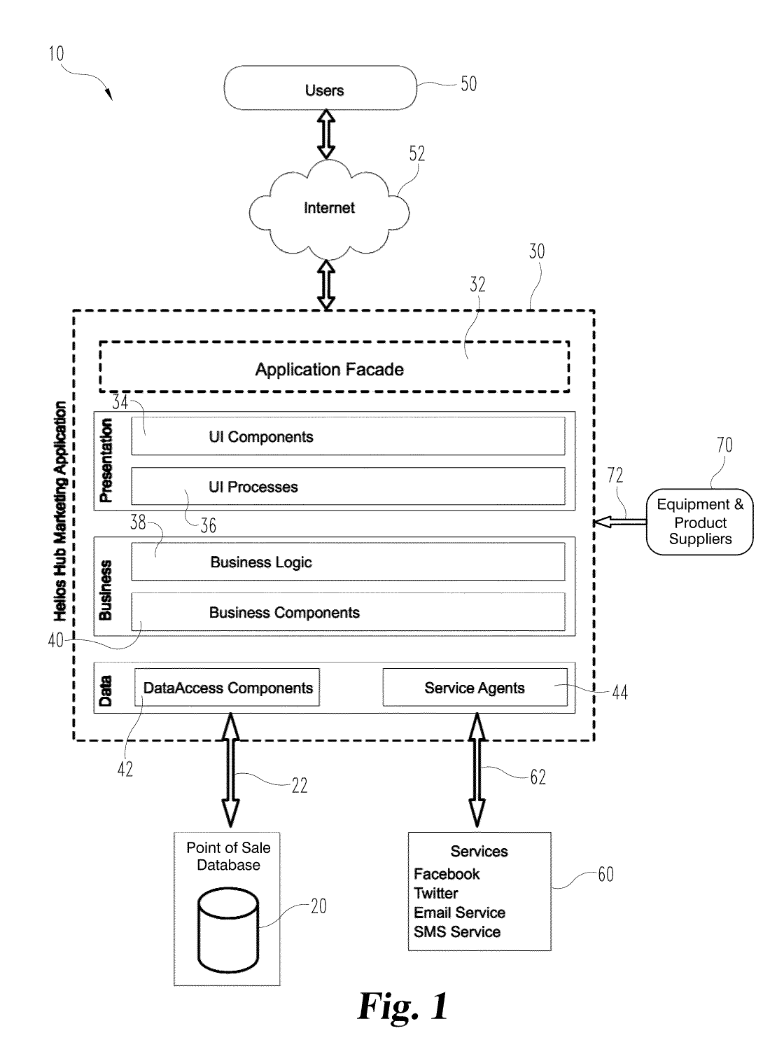

Turning to FIG. 1, a diagrammatic view of system 10 suitable for use in certain embodiments of the present invention is shown. System 10 incorporates a point of sale provider database 20 storing information on subscribed customers, such as tanning salon customers. The provider database 20 is linked via a computer communication link 22 with a marketing management software application 30 provided by a software provider. The software application 30 includes an application façade or user interface 32 visible to users 50, typically representatives of the point of sale provider, via a communication link 52. Software 30 incorporates aspects including user interface components 34, user interface processes 36, business logic processing 38 and business components 40. The software 30 is connected via a communication link 22 to the provider database 20 and also connects via communication links 62 to electronic communication distribution services 60. In certain embodiments, one or more equipment and product supplier/manufacturer 70 databases have a communication link 72 to software 30 to transfer or to allow access to content material relevant to that supplier.

System 10 may include several servers, such as a point of sale provider server hosting database 20, a software provider server hosting software 30, user computers or servers allowing access to interface 32 and optionally one or more equipment and product supplier servers providing access to equipment and product related content. While the computers are each illustrated as being a server or client, it should be understood that any of the computers may be arranged to include both a client and server. Furthermore, it should be understood that while a specific number of computers are illustrated, more or fewer may be utilized in alternative embodiments. In particular, it shall be appreciated that a large number of computers, such as computers for multiple users 50, for multiple point of sale databases 20 and for multiple equipment and product suppliers 70, may be in use within system 10 for performing operations such as allowing numerous individual entities to connect to and use system 10.

Turning to implementation specifics, in the illustrative embodiment, the computers include one or more processors or CPUs and one or more types of memory. Each memory preferably includes a removable memory device. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM, i3, i5 or i7 processors supplied by INTEL Corporation of 2200 Mission College Boulevard, Santa Clara, Calif. 95052, USA.

Each memory (removable or generic) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Although not shown, in one embodiment each computer is coupled to a display and/or includes an integrated display. Computers may be of the same type, or a heterogeneous combination of different computing devices. Likewise, displays may be of the same type, or a heterogeneous combination of different visual devices. Although not shown, each computer may also include one or more operator input devices such as a keyboard or mouse to name just a few representative examples. Also, besides a display, one or more other output devices may be included such as a printer. As such, various display, input and output device arrangements are possible.

The various communication links can be in the form of a wireless or wired Local Area Network (LAN), Municipal Area Network (MAN), Wide Area Network (WAN), such as the Internet, a combination of these, or such other network arrangements as would occur to those skilled in the art. In a further form, several computers, such point of sale provider servers and the software hosting server may be coupled together by a secure portion of a network while remaining connected to unsecured portions of a network such equipment supplier or customer servers or electronic communications systems. The operating logic of system 10 can be embodied in signals transmitted over a network, in programming instructions, dedicated hardware, or a combination of these.

In one embodiment, system 10 operates at one or more physical locations where a web server is configured to host application business logic for a dynamic message delivery service, the database server is configured to store content segments received from an entity and end user information, and a client computer is configured for providing user interface 32, for allowing a representative of an entity of interest to interact with the service, such as to enter user information, create/upload content segments, and/or initiate/manage the distribution of a batch of communications. It shall be appreciated that in alternate forms a user computer may be any web-enabled device, such as a PDA, Blackberry, iPhone, iPad, smart phone or tablet computer, to name just a few illustrative examples. Furthermore, user interface 32 of software 30 may be an installable application such as one that communicates with a Web Server, browser-based, and/or embedded software, to name a few non-limiting examples.

In one embodiment, software installed locally on user 50 computers is used to communicate with software 30 server. In another embodiment, the software 30 server provides HTML pages, data from web services, and/or other Internet standard or company proprietary data formats to one or more user computers when requested. One of ordinary skill in the art will recognize that the term web server is used generically for purposes of illustration and is not meant to imply that the network is required to be the internet.

Additionally, software 30 includes business logic 38 and associated hardware 40 allowing access to provider database 20 via data access components 42, access to communication services 60 via service agents 44 and access to equipment and product databases 70. In one form the business components 42 and data access components 42 or service agents 44 may initiate a digital communication session with database 20 or communication services 60. Further, it shall be appreciated that the types of communication methods connected within system 10 need not be of the same type, but that digital, analog, and other technologies may be accommodated simultaneously.

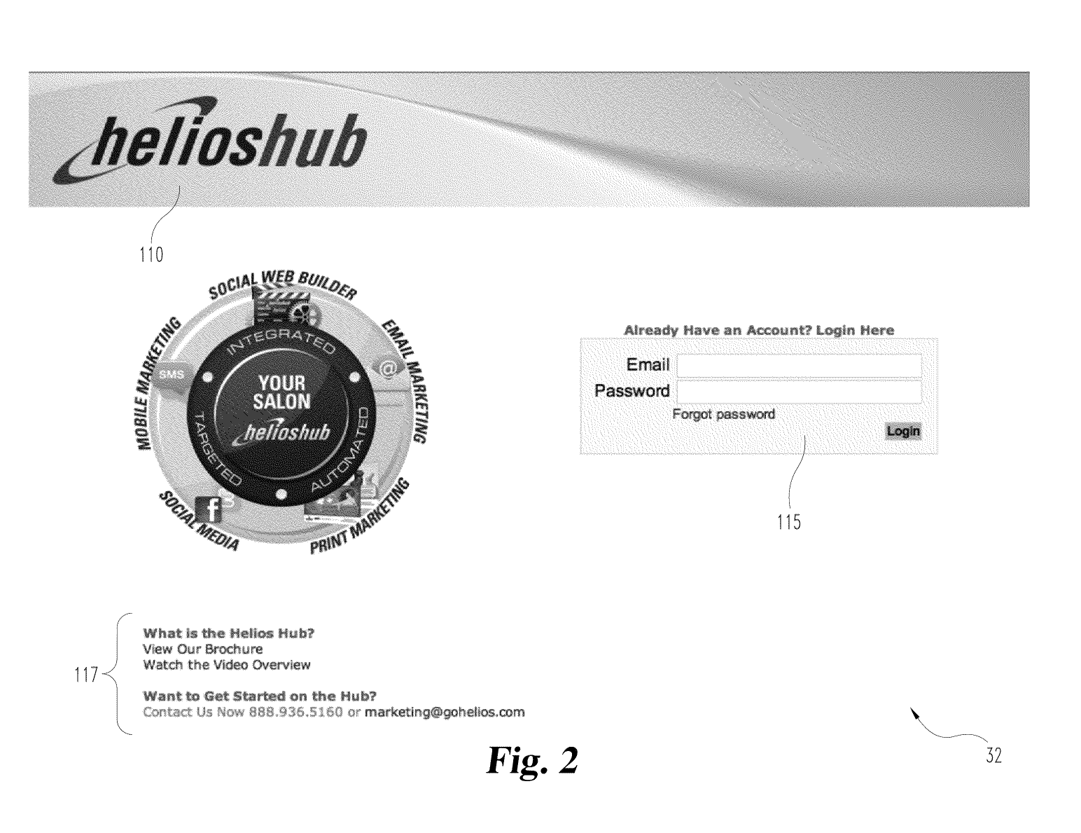

Illustrated in FIG. 2 is an example graphical user interface screen which functions as the initial application façade 32 visible to a user 50 when the user 50 accesses system 10. The various screens discussed herein all form portions of the façade 32, but are discussed separately for ease of description. FIG. 2 illustrates an example publicly accessible welcome screen 110. The welcome screen 110 can display identifying indicia such as a banner logo with additional information provided in the body of the screen or accessible via information links 117. A user can login to access secure aspects of system 10 with a username, such as an email address, and a password via login feature 115. Login and access control can be specified by a system administrator at one or more of the software provider and the point of sale provider, with each optionally having one or more users and optionally having different access levels and controls, such as read only, read-write, read-write-delete, or administrator privileges.

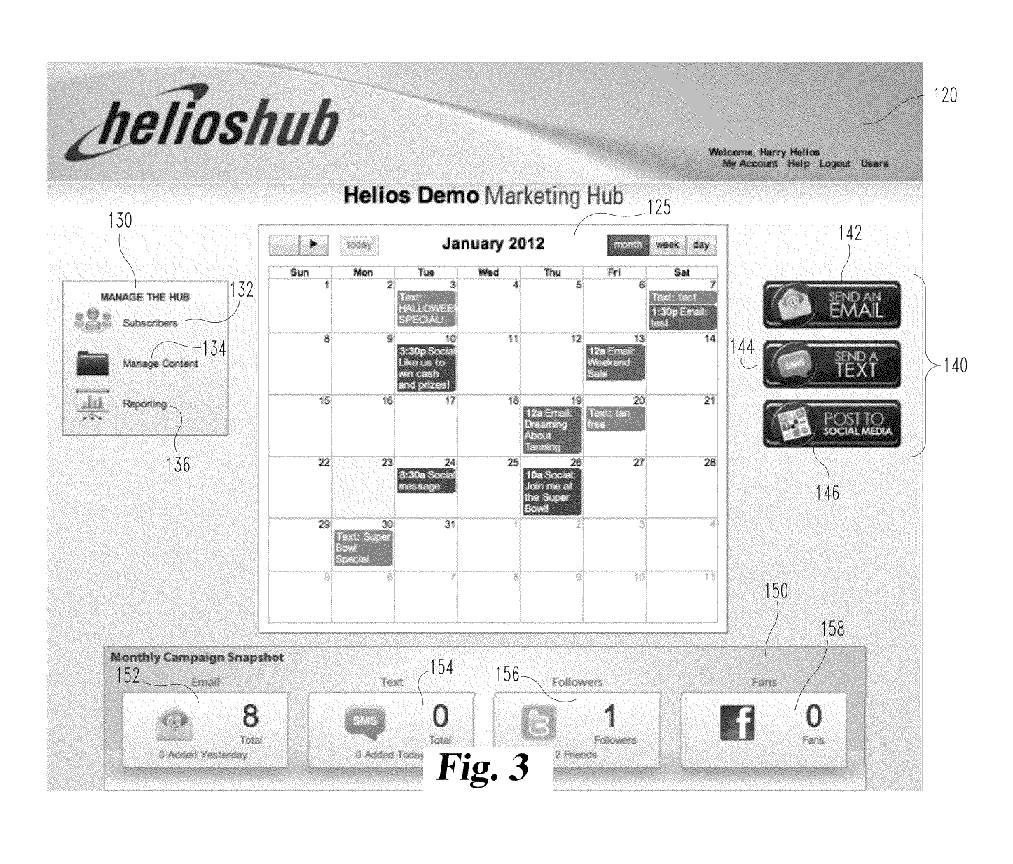

Once a user has logged into system 10, the user reaches the primary screen 120 illustrated in FIG. 3. Primary screen 120 includes information and access links to additional features of the system. For example, screen 120 features a calendar 125 displaying information on different communications that have occurred or which are scheduled. A management area 130 includes links to control functions, a composition area 140 includes links to communication creation options, and a snapshot section 150 includes information and links to communication and social media status information. For example, management area 130 includes a subscriber link 132, a manage content link 134 and a reporting link 136. The composition area 140 includes a create email link 142, a create text message link 144 and a post to social media link 146. The snapshot area 150 includes display information regarding emails 152, text messages 154, and social media links 156 and 158 regarding social media and marketing forums such as offered by FACEBOOK, Inc. or TWITTER, Inc. Navigation cross-links within software 30 are included in various screens, but are not described in each instance.

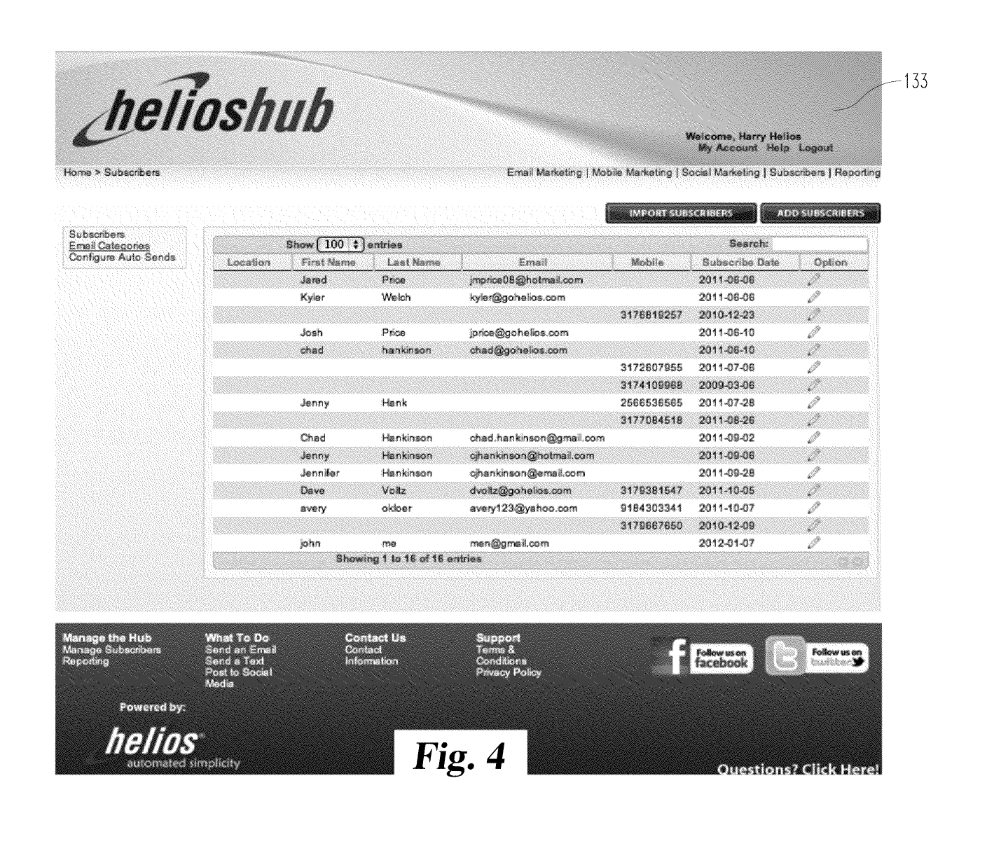

Upon selecting the subscriber link 132, the user is directed to subscriber screen 133, illustrated in FIG. 4. As examples, the subscriber screen displays information regarding the point of sale provider's subscribed customers. The customer information may be stored within the software provider's system or preferably is stored in the point of sale provider's local database 20. Customer information and purchasing history is dynamically updatable at the provider's point of sale in response to each customer's purchase and use of the point of sale provider's services and goods and is continuously or periodically accessed via communication link 22. Alternately, updated information can be batch uploaded from database 22 to the software provider's system at selected intervals. Subscriber screen 133 displays customer information such as a name and contact information such as email and text message addresses. Subscriber screen 133 preferably allows editing of the list such as importing or adding subscribers individually or in batches and allows individual subscriber information to be edited or removed as desired. Additional customer information screens (not shown) may display information on a customer's purchasing history and patterns.

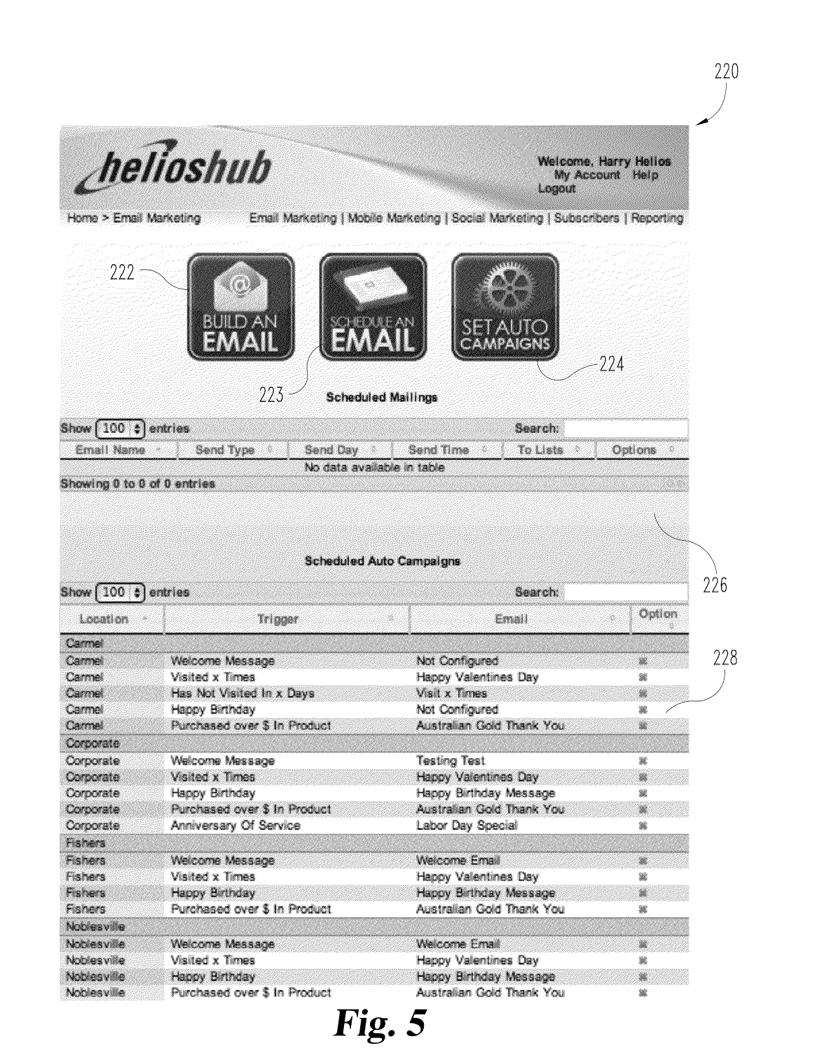

When the email link 142 is selected, the user is directed to email page 220 illustrated in FIG. 5. Email page 220 includes options to allow a user to select to create an email 222, to schedule an email to be sent 223 or to manage automatic email distribution campaigns 224. Email page 220 further includes status and summary info such as panel 226 summarizing past or future scheduled email messages, and panel 228 summarizing automatic email campaigns. Scheduled or automated email messages can be customized by selected locations, a triggering event interacting with the customer database, and/or other criteria defined by the user.

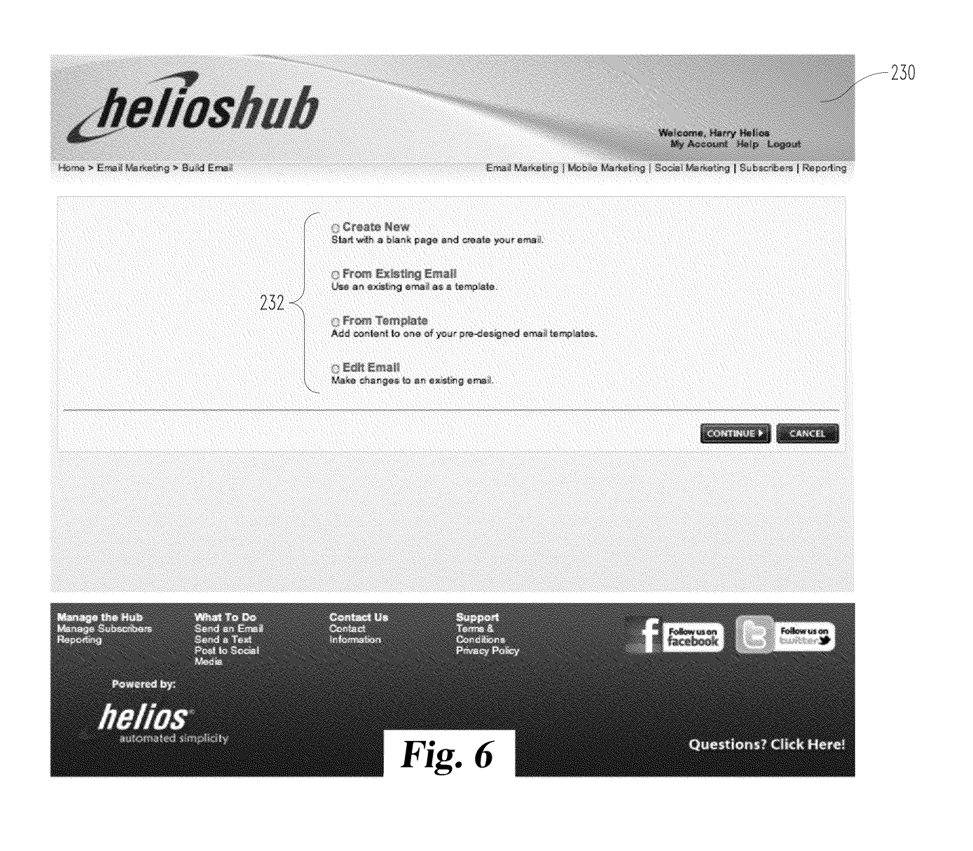

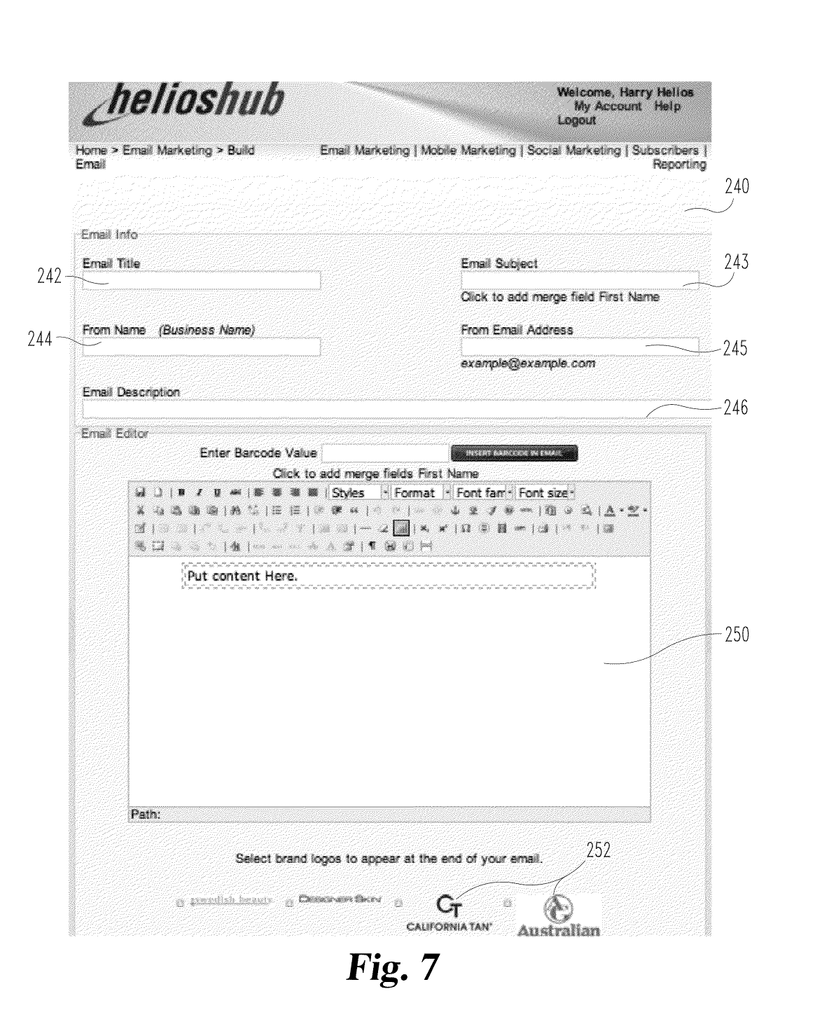

FIG. 6 illustrates an email creation page 230, with selection criteria 232, for instance allowing a user to create an email message or campaign, to design an email based on a prior email message or a template or to edit an existing email message or campaign. For example, upon selecting to create a new email, screen 240 as shown in FIG. 7 is displayed to a user. The user can enter appropriate identifying information in designated fields, examples include a title 242, a subject 243, a from name 244, a from address 245 and an identifying description 246.

After entering identifying information, the user may use panel 250 to create the content of the email message. Panel 250 may be a text editable field and preferably allows the incorporation and placement of text and graphic images. For example, text editing tools arranged in toolbars and control buttons are accessible adjacent panel 250. In certain options, brand logos 252 or similar graphics corresponding to goods offered for sale or equipment used by the point of sale provider are accessible and can be incorporated into the content of the email message. Preferably, the logo images are supplied to the software provider by the equipment and product suppliers 70 and may be updated in software system 30 by the equipment and product suppliers at will to ensure that preferred artwork for the logos is available for inclusion in email messages. The email message may optionally include a feature to insert a bar code to enable a printed or electronic image of the email message to be scanned at the service provider's point of sale, for example for redemption as a coupon.

In certain options, the communication may include merge fields which present specific text or information to a customer based on that customer's information in the point of sale database 20. The specific text or information may copy specific information such as the customer's name, or information may be calculated and provided based on logic rules applied to information stored in the database.

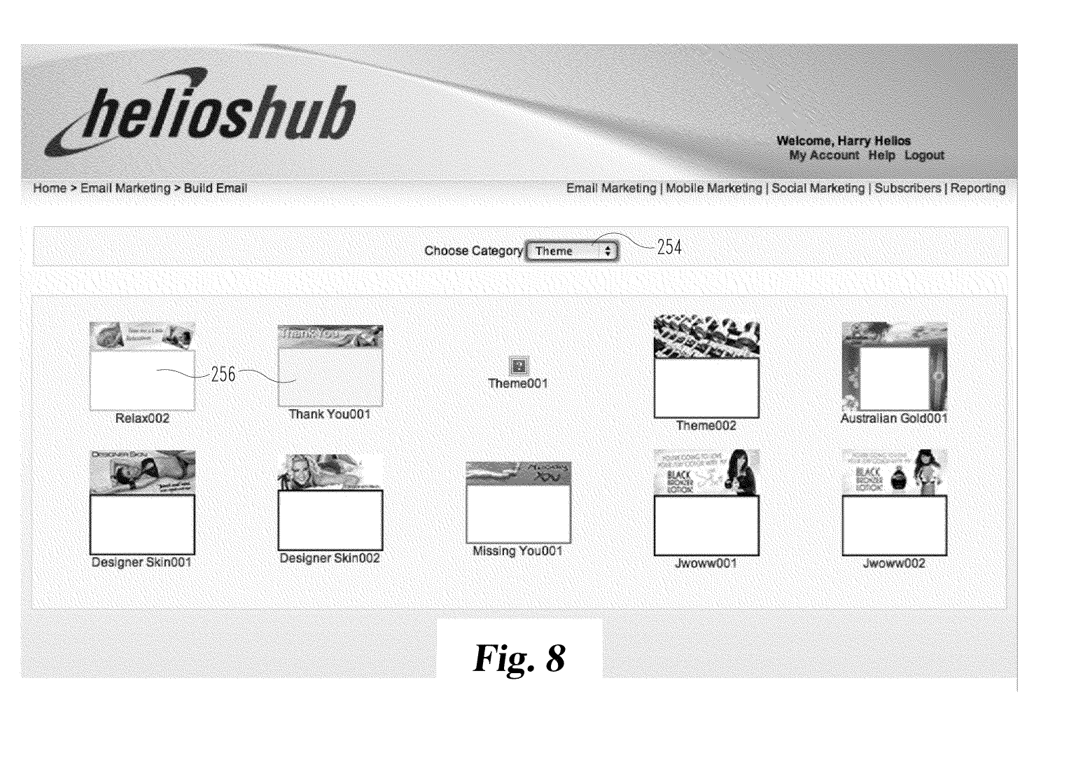

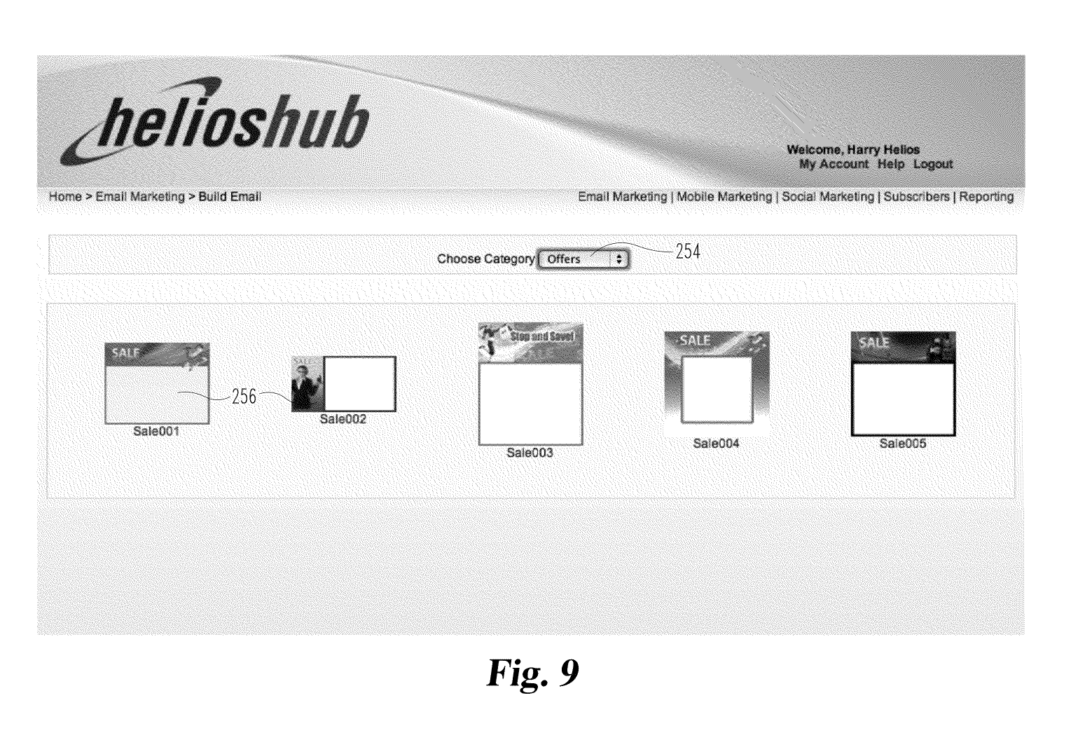

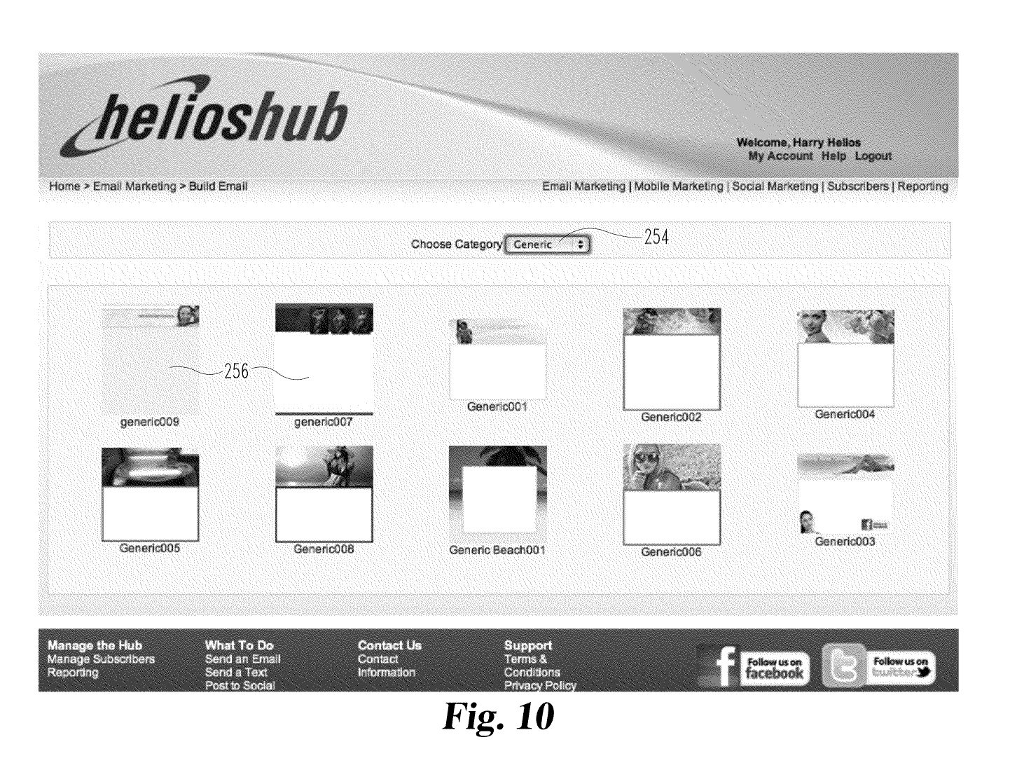

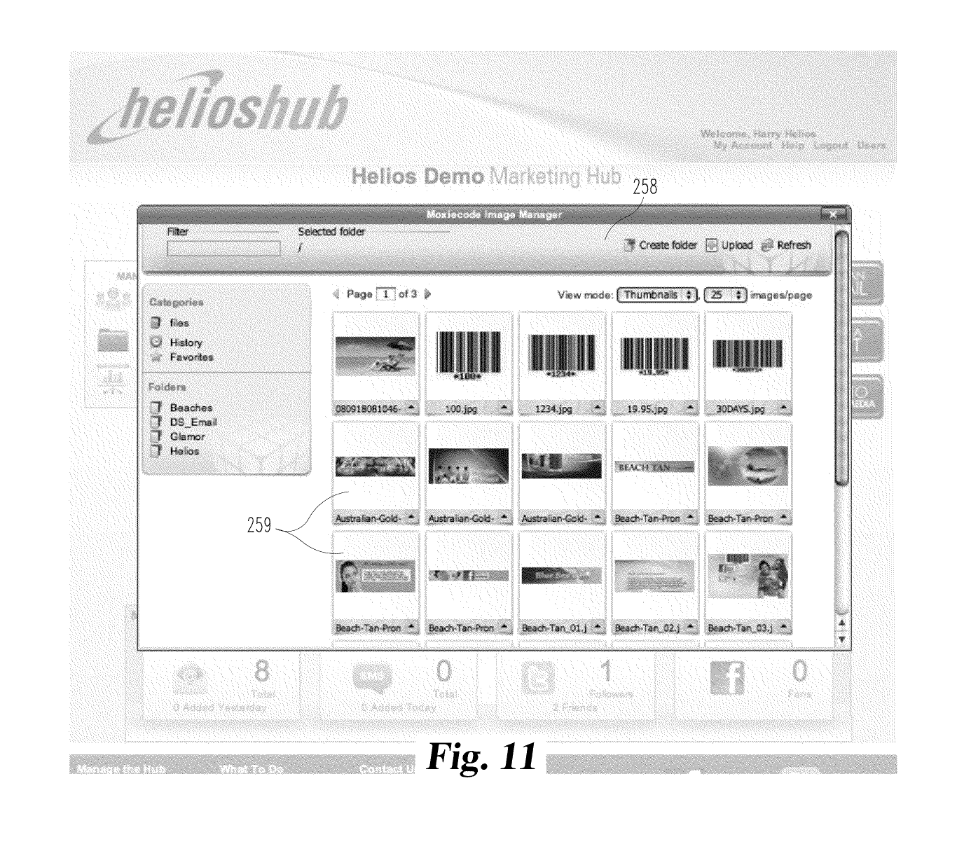

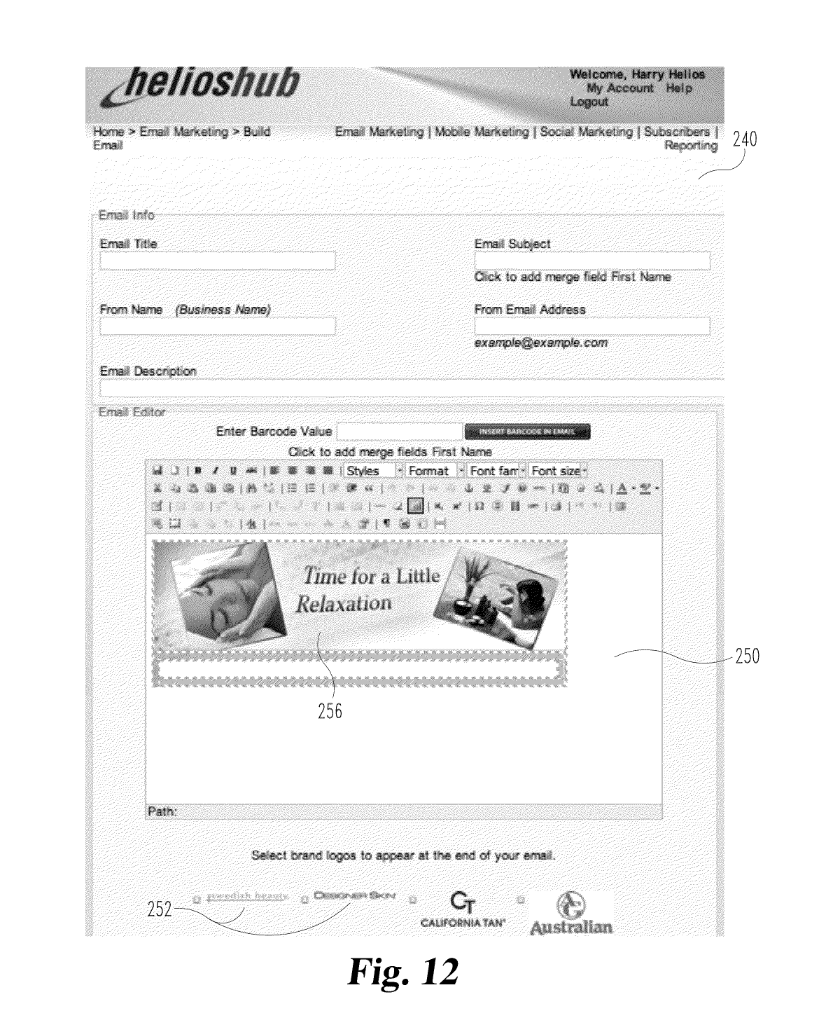

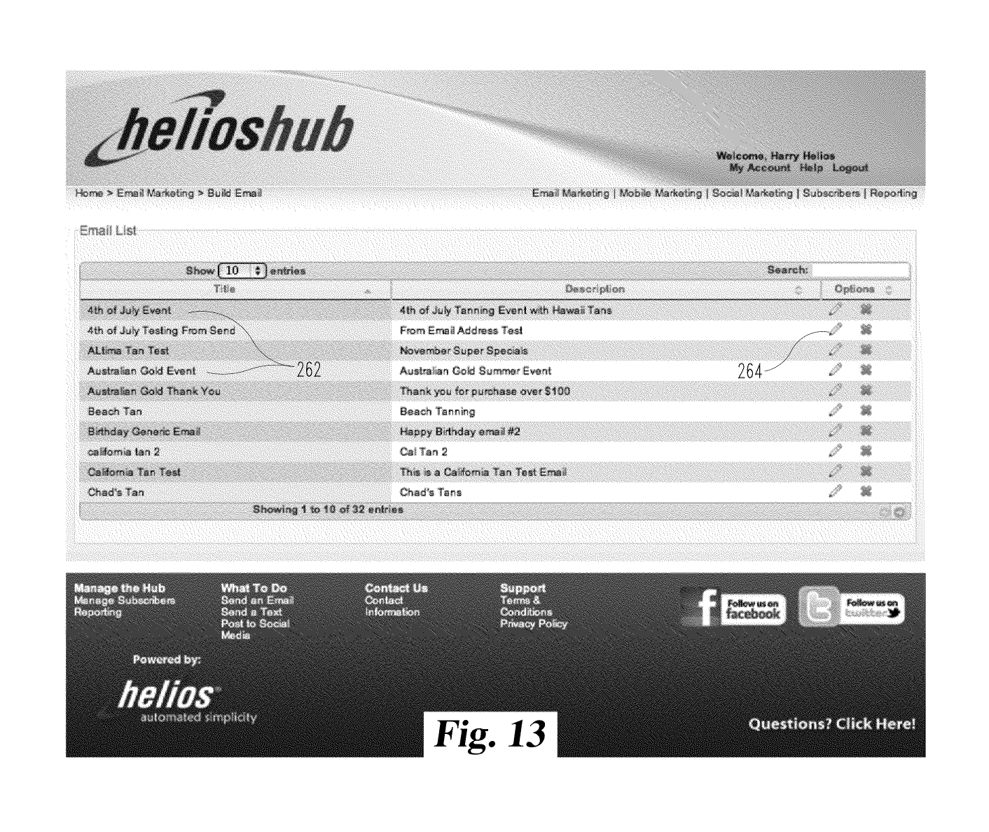

FIGS. 8-11 illustrate email message templates 256 and images 259 which can be used as pre-programmed elements which can be inserted into the body of an email message, as shown in FIG. 12. The templates and images may be added to a new email, may be used to create an email from a template or to edit an existing email message. The templates may, for example, comprise banners or background elements and the images may be generic such as scenery, stock messages or stock themes, or may be product/equipment specific images or information. Optionally certain templates and images are provided by the software provider. In certain embodiments, addition, removal or alteration of images stored in or accessible via software 30 may be made by authorized respective equipment and/or product suppliers 70 and may be updated at will in the supplier databases or in software system 30 by the equipment and product suppliers to ensure that preferred and current images and information are available for inclusion in email messages. As a summary, FIG. 13 illustrates a list of email messages 262 and provides the ability via options 264 to edit and manage the email messages 262.

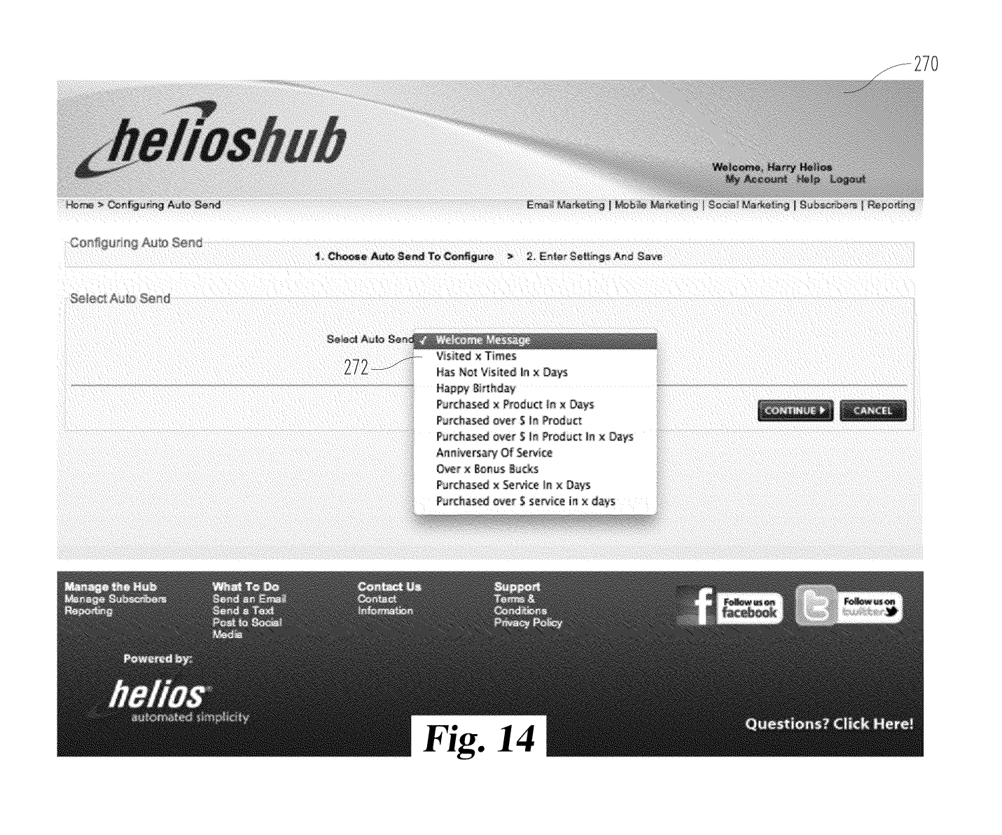

An auto configuration screen 270 illustrated in FIG. 14 can be used to create automatic sending criteria for email, text or other messages. For example, screen 270 allows a user to select a specific triggering criteria type 272 to be chosen, after which the user is directed to a second part of the configuration screen 270 to program the triggering criteria.

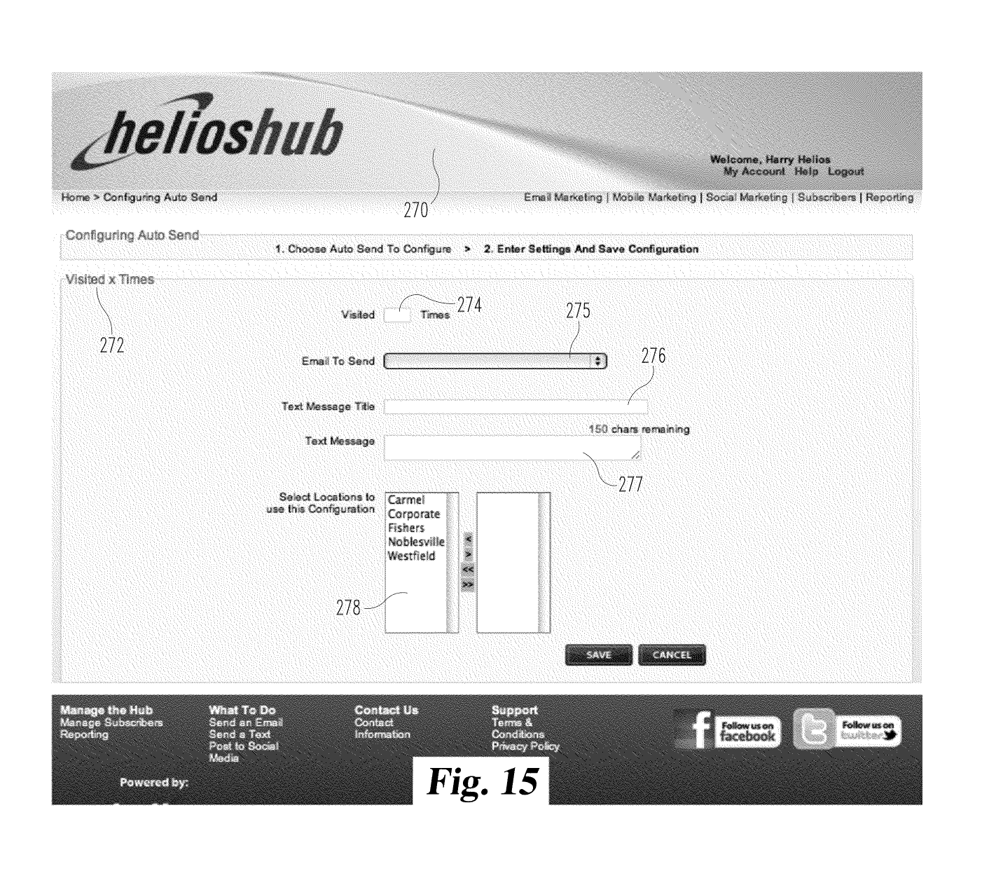

FIG. 15 illustrates where selected triggering criteria 272 such as “Visited x Times” can be configured. The configuration screen defines a selected trigger criteria, such as one or more logic fields 274 where user-defined parameters can be input. Example logic fields can be addition of a new customer, a calendar event such as a birthday or anniversary, or customer purchasing history measured performance information such as a certain number of visits or a certain amount of purchased goods or services.

In certain embodiments, the email content is specifically tailored to the customer and triggered by criteria in response to the customer's purchasing history at the point of sale provider's physical location. These criteria may be generic, such as purchasing a certain dollar amount of products or services, or may be industry specific. The triggering logic may be also be single or multi-variable based. For example triggering criteria may include one or more of if a customer has either purchased a certain dollar amount of products, if a customer has purchased a certain amount of units or sessions, or if a customer has visited the provider in a certain period of days.

In other embodiments, the logic and criteria may trigger a communication tailored to a customer's known or detected purchasing patterns. For example in the tanning industry, the criteria may be tailored to only send communications regarding sunless or spray-tanning sessions and products if the customer has only indicated interest in or has only used sunless tanning sessions in the past and has not indicated interest in ultraviolet tanning options. In another example, if a customer has purchased a specific preparation or brand of tanning preparations, the logic could trigger a message sending information or discounts on that specific preparation and/or could base a recommendation or offer a discount for a different tanning product or a complimentary product in the same or a different brand that the customer might want to try as a substitute or improvement for the previously purchased product. For example, an after-tan moisturizer could be promoted as complimentary to a tanning preparation.

In certain preferred embodiments, the logic fields include options to include criteria based on industry based patterns or guidelines. For example in the tanning salon industry, a customer may purchase a tanning preparation in a certain amount, which is normally used at an average expected rate per session, allowing an expected number of sessions of use to be calculated. The industry based patterns may include triggering criteria to send a communication when the number of customer sessions after the purchase approaches or equals the expected amount of sessions to exhaust the purchased amount and can remind the customer to purchase an additional amount of tanning preparation. In certain options, a discount, recommendations of similar products, recommendations of potential alternate products of interest, or other product purchasing inducement can be offered to the customer.

In another tanning industry based example, on-site tanning advisors typically provide consultation on a recommended ultraviolet or sunless exposure level and time in a certain level/type of tanning bed or booth for a next session based on the customer's skin type and tanning history and industry guidelines. As certain logic criteria fields, the communication may incorporate information on the customer's skin type and tanning patterns to recommend a likely exposure level and timing for the customer's next visit to the location. As more complex options, the communication may provide information on what recommended exposure levels and times would be on alternate types of tanning beds or booths available at the point of sale location, so the customer may have a selection and time commitment in mind before arriving at the location.

In a still further example, certain tanning preparations are recommended for certain types of tanners based on their skin type, base tan and tanning history, such as “Step 1,” “Step 2” and “Step 3” levels of products. In certain embodiments, the communication may be tailored to recommend that a customer stay at a given level or to offer that it may be appropriate to increase to a higher or lower level. The communication may correspondingly offer a discount or other inducement to purchase a recommended type of tanning session or preparation.

In alternate examples, the tanning industry generally includes recommendations of not-to-exceed guidelines to minimize over-exposure or over-use of ultraviolet tanning equipment. In situations where a potential concern for a customer is detected, a communication could be triggered providing an alert or warning to the customer and/or suggesting recommendations. An example recommendation would be to suggest use of a sunless or spray-tanning session instead of too high a frequency of use of an ultraviolet bed or booth.

After a message is created, the user may define an auto send campaign by selecting one or more distribution methods such as an email message 275 or a text message title 276 and content 277, and can select other criteria such as which point of sale locations 278 the auto send campaign is applicable to. Optionally, other distribution methods for sending messages, such as telephone audio messages, fax messages, instant messages, or social media communications can be used. Once an auto send campaign is saved within software 30, software 30 preferably dynamically interacts with the point of sale provider database 22 and automatically initiates distribution of the programmed communication to qualifying customers when the customer's purchasing history matches the triggering criteria.

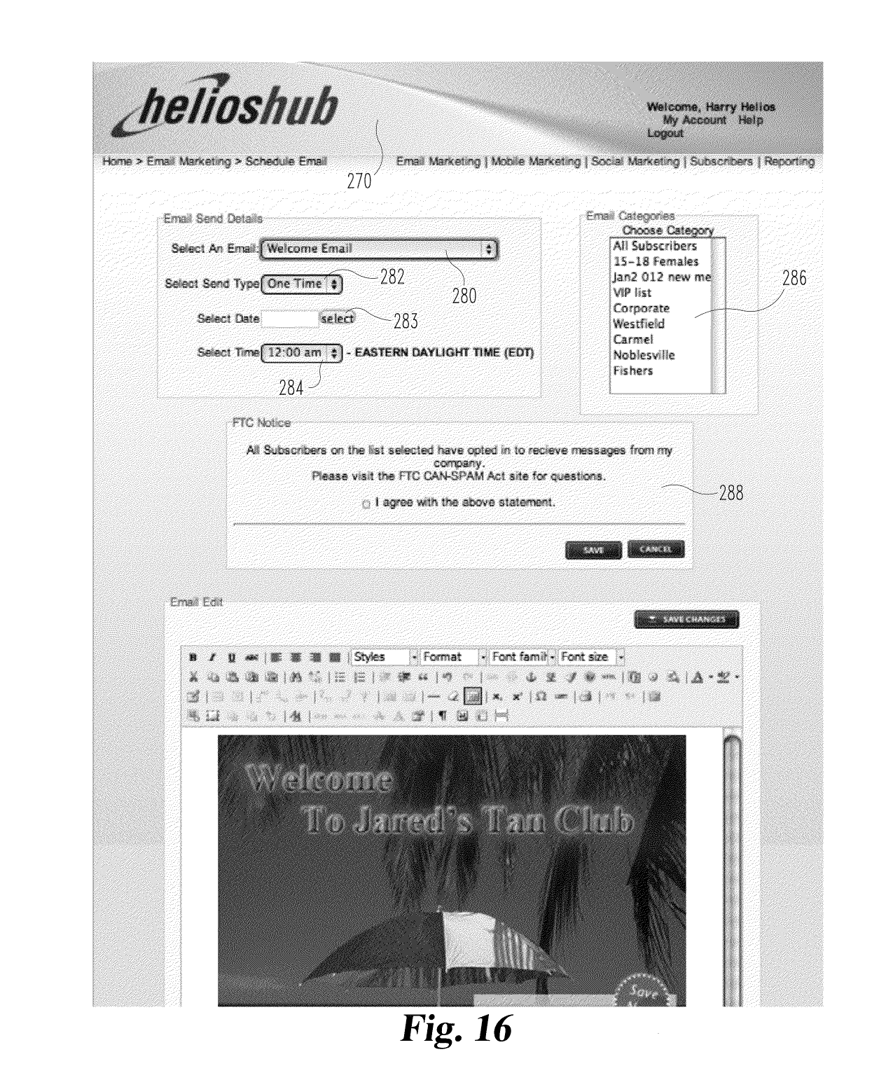

FIG. 16 illustrates scheduling screen 270 for scheduling specific delivery of a message, such as an email message. In the illustrated embodiment, a user can select an email 280 using a drop-down box or similar selection criteria from previously created email messages. The user can then program a recurrence type 282 if desired and/or a delivery date 283 and time 284. The user can select 286 whether the message goes to all or a subset of subscribed customers in the point of sale provider's database, and preferably yet optionally verifies that the message is being sent only to subscribed customers. Optionally, the selected email message can be previewed and/or edited from screen 270.

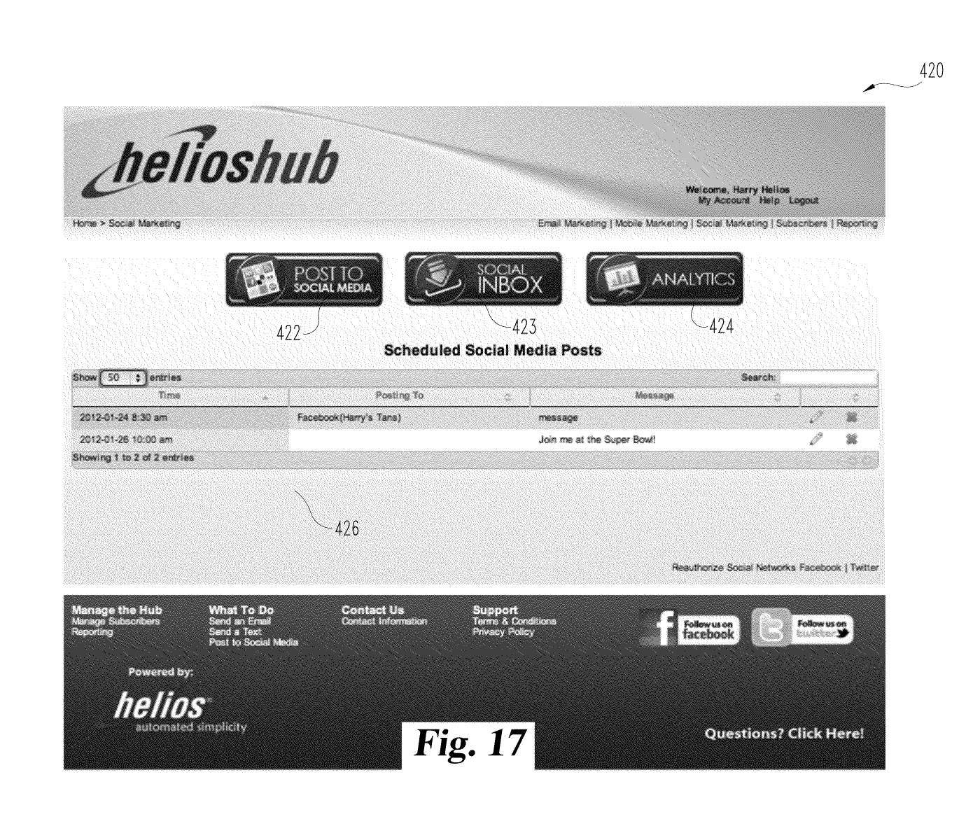

In certain embodiments, system 10 incorporates features to send or post messages to social media and/or to monitor social media sites, such as on the internet. FIG. 17 illustrates social media control screen 420, including controls such as to post messages 422, to review an inbox of messages 423 and to access analytical tools 424. Screen 420 may also include a panel 426 summarizing scheduled social media communications, including information on timing, destination, content and options to edit or delete a scheduled communication.

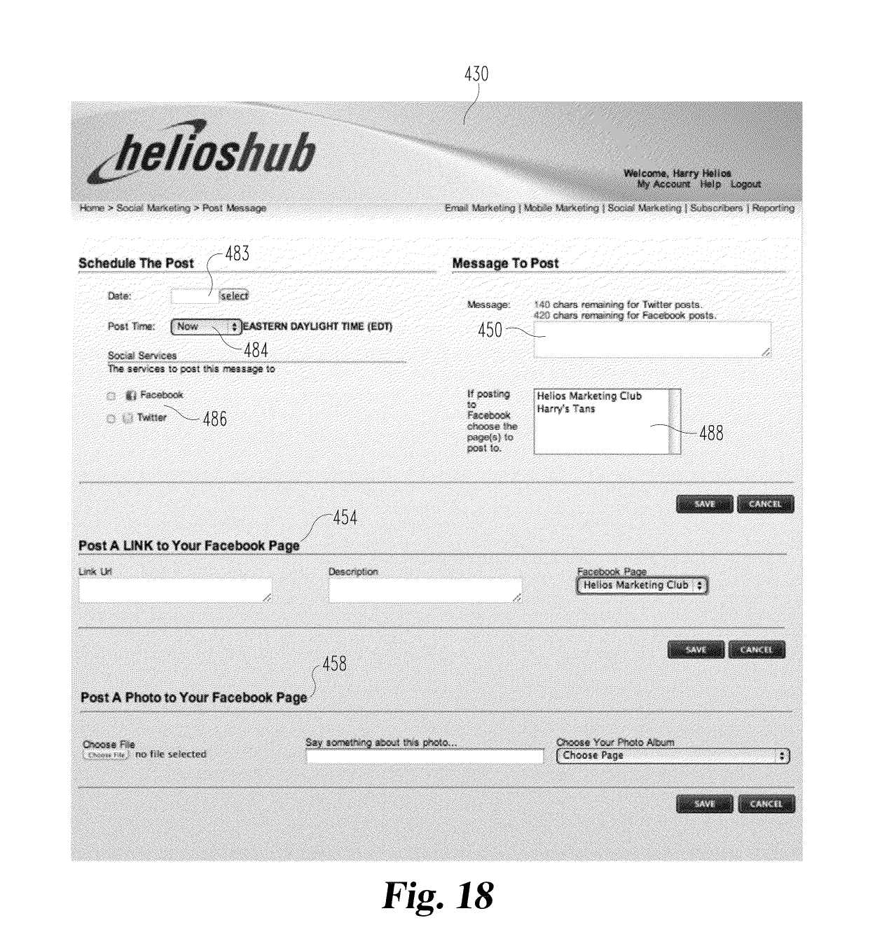

Scheduling screen 430 in FIG. 18 illustrates an example tool for scheduling social media communications. A user can first select and configure date 483 and time 484 criteria for a desired communication, as well as selecting one or more social media platforms 486, such as offered by FACEBOOK, Inc. or TWITTER, Inc., to which the communication is sent. In certain methods, sub-options such as a specific FACEBOOK page can be selected 488. The user may create or input a message in a content panel 450 and may build and incorporate link information 454, photographs 458 or other content into the communication. Optionally, system 10 incorporates links or images supplied to the software provider by the equipment and product suppliers 70 which may be accessible to or updated in the software system by the equipment and product suppliers at will to ensure that preferred up-to-date information is available for inclusion in communications.

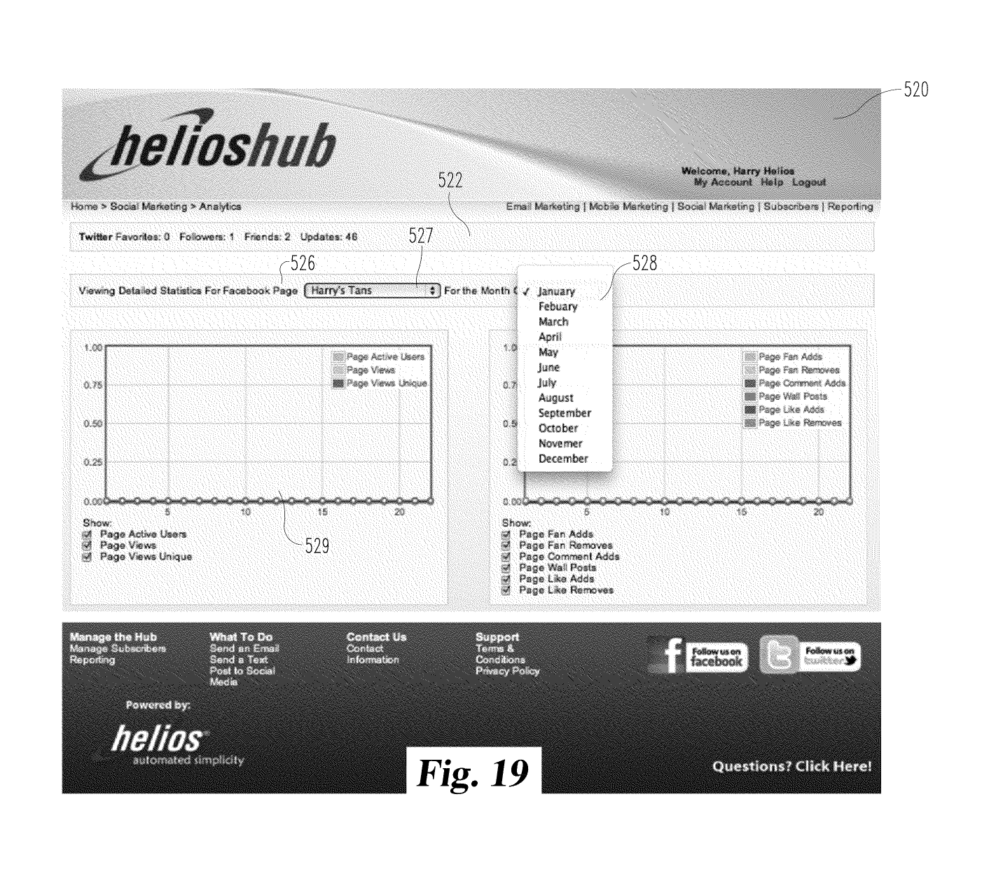

A sample analytics or reporting screen 520 is illustrated in FIG. 19. Analytics screen 520 optionally includes charts or similar graphic and/or numeric/textual indicia reporting on the point of sale provider's social media communications. For example, the TWITTER report panel 522 includes a summary of the point of sale provider's favorites, followers, friends and updates. A FACEBOOK report panel 526 includes selection criteria such as to specify a date 526 and time period 527, and then includes one or more reports or charts 529 illustrating associated page activity, for example the charts or reports can convey information on active users, the number of page views and unique page views, the number of fans or likes added or removed, wall postings or comments added.

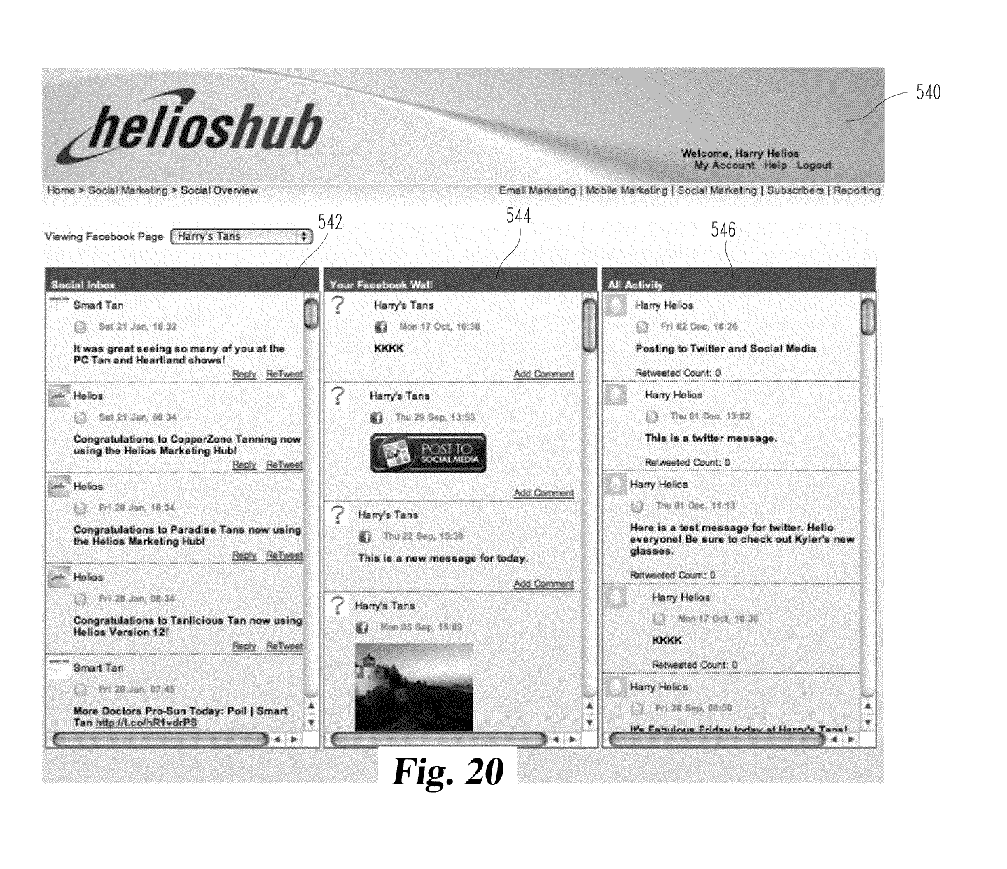

A social overview screen 540 is illustrated in FIG. 20. Social overview screen 540 preferably provides a dashboard or summary view of social media activity associated with the point of sale provider. In the illustrated example, the social overview screen 540 illustrates activity on three social media communication platforms such as showing messages from a TWITTER social inbox 542, postings on a FACEBOOK wall 544 and an all activity summary 546. Preferably the associated panel for each social media platform is scrollable to view additional activity, and each message serves as a link allowing a user to expand and view the message, to forward the message, to provide a comment or to otherwise respond.

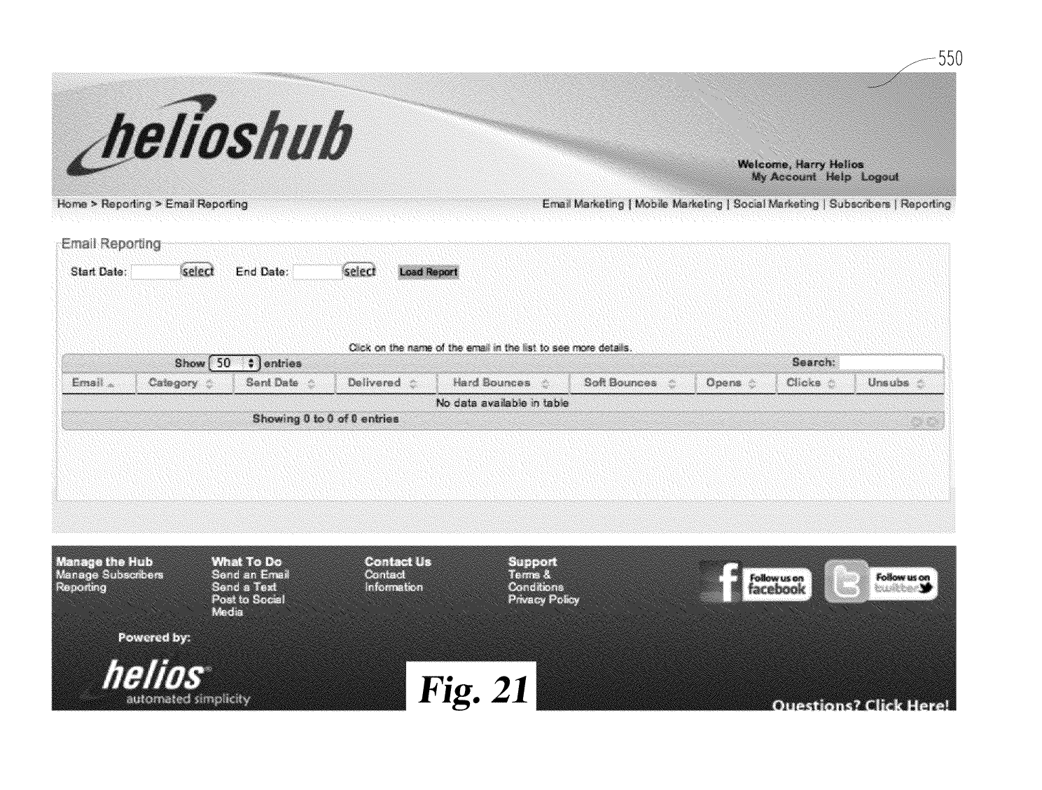

In a further optional feature, software 30 preferably includes an email reporting screen 550 shown in FIG. 21. Email reporting screen summarizes information regarding email messages which have been sent, including for the example, the email message name, category, send date, delivery confirmation, bounce or non-delivery information and measures results such as the number of customers who opened the email, clicked upon a link in the email or unsubscribed in response to the email.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A computer implemented method for managing tanning salon marketing, comprising:
maintaining a point of sale provider database storing information on subscribed tanning salon customers who are obtaining tanning services or products at a tanning salon point of sale location operated by a point of sale provider, wherein said provider database is updated in real-time with information regarding each customer's purchase of tanning services and products at the point of sale location;
accessing a marketing management software application provided by a software provider, wherein said marketing management software application is in linked communication with said point of sale database;
electronically accessing said marketing management software application to create one or more targeted electronic marketing communications to be delivered via one or more selected electronic communication methods to subscribed customers based on user defined selection criteria;
wherein said user defined selection criteria incorporates logic based upon indoor tanning industry based criteria and parameters defined by the user; and,
wherein said software application automatically sends targeted electronic marketing communications to a customer when that customer's purchasing history matches the criteria.

2. The method of claim 1, wherein said software application sends a targeted electronic communication to a customer recommending use of a specific type of ultraviolet equipment and exposure time for that customer's next tanning session at the point of sale location based on that customer's skin type and tanning history in accordance with industry recommended guidelines.

3. The method of claim 1, wherein said software application sends a targeted electronic communication to a customer identifying options for use of different types of ultraviolet tanning beds or booths available for use at that customer's next tanning session at the point of sale location, including calculated suggested exposure times for the different options based on that customer's skin type and tanning history in accordance with industry recommended guidelines.

4. The method of claim 1, wherein said software application sends a targeted electronic communication to a customer based upon that customer's purchasing patterns at the point of sale location.

5. The method of claim 4, wherein said software application sends a targeted electronic communication to a customer recommending purchase of an additional amount of indoor tanning preparation when the number of customer sessions after a prior purchase of a tanning preparation approaches is predicted to be exhausted based on the amount of tanning preparation previously purchased and that customer's number of tanning sessions in accordance with an expected rate of use of the tanning preparation per session.

6. The method of claim 4, wherein said software application sends a targeted electronic communication to a customer offering an inducement to purchase the same type of indoor tanning preparation previously purchased by that customer.

7. The method of claim 4, wherein said software application sends a targeted electronic communication to a customer offering an inducement to purchase a different type of indoor tanning preparation than a type previously purchased by that customer.

8. The method of claim 7, wherein said software application sends a targeted electronic communication to a customer offering an inducement to purchase a different type of indoor tanning preparation than a type previously purchased by that customer, wherein the recommendation is based on that customer's skin type and tanning history.

9. The method of claim 4, wherein said software application sends a targeted electronic communication to a customer providing an alert or warning if a pattern is detected that may indicate potential over-use of ultraviolet tanning equipment.

10. The method of claim 9, wherein said software application sends a targeted electronic communication to an individual providing a recommendation or inducement to purchase alternate products or to use alternate equipment if a pattern is detected that may indicate potential over-use of ultraviolet tanning equipment.

11. A computer implemented method for managing tanning salon marketing, comprising:
providing a marketing management software application from a software provider,
accessing a point of sale provider database storing information on subscribed tanning salon customers who are obtaining tanning service and products at a tanning salon point of sale location operated by a point of sale provider, wherein said marketing management software application is in linked communication with said point of sale database;
wherein said marketing management software application incorporates marketing content from one or more suppliers who have provided equipment used in providing services or products offered for sale at the point of sale provider's point of sale location; and,
wherein said marketing software enables a user to access said software to electronically create and schedule delivery of targeted electronic marketing communications to subscribed customers via one or more selected electronic communication methods and wherein said user can incorporate said marketing content from one or more suppliers into said electronic marketing communication.

12. The method of claim 11, wherein said suppliers can update said marketing content at will.

13. The method of claim 12, wherein said marketing content is stored in the software application and can be updated by said suppliers accessing said software application.

14. The method of claim 12, wherein said marketing content is stored on supplier computer systems, and wherein said software application is in linked communication with said supplier computer systems to access said content at will.

15. The method of claim 12, wherein said marketing software enables a user to electronically create a targeted electronic marketing communication to a customer based on that customer's purchasing history and wherein said communication incorporates specific marketing content in response to that customer's purchasing history.

16. The method of claim 15, wherein said communication incorporates selected tanning preparation marketing content based on that customer's purchasing history of tanning preparations.

17. The method of claim 15, wherein said communication incorporates selected tanning preparation content based on that customer's purchasing history of ultraviolet tanning sessions.

18. The method of claim 18, wherein said communication is sent to a public social media forum.

19. The method of claim 18, wherein said software incorporates a social media monitoring and reporting function which simultaneously displays communication activity from two or more forms of social media.

20. A computer implemented method for managing tanning salon marketing, comprising:
maintaining a marketing management software application provided by a software provider,
wherein said marketing management software application is in linked communication with a point of sale database storing information on the purchasing history of subscribed tanning salon customers who obtain tanning service and products at a tanning salon point of sale physical location operated by a point of sale provider, wherein each customer's purchasing history is updated in real-time with information on that customer's purchase of tanning services and products at the point of sale location;
wherein said marketing management software application incorporates marketing content from one or more suppliers who have provided equipment used in providing services or products offered for sale at the point of sale provider's point of sale location; and
allowing a user to electronically access said marketing management software application to create and schedule automatic delivery of a targeted electronic marketing communication via selected electronic communication methods to a subset of the subscribed consumers and wherein said user can incorporate said supplier provided marketing content into said electronic marketing communication;
wherein said subset of subscribed consumers is defined by comparing user defined selection criteria incorporating indoor tanning industry based criteria, to information regarding each customer's purchasing history, wherein said indoor tanning industry based criteria is updated and maintained by the software provider.
